(19) United States
(12) Patent Application Publication
(10) Pub. No.: US 2025/0360507 A1
(43) Pub. Date: Nov. 27, 2025

(54) Microfluidic System Having an Ion Exchanger Mixed-Bed Resin

(71) Applicant: Robert Bosch GmbH, Stuttgart (DE)

(72) Inventors: Franz Laermer, Weil Der Stadt (DE); Britta Schulze, Kehl (DE); Janik Kaercher, Küsnacht (CH); Samir Kadic, Langenau (DE); Tianxing Du, Freising (DE)

(21) Appl. No.: 18/875,150

(22) PCT Filed: Jun. 14, 2023
(86) PCT No.: PCT/EP2023/065896

§ 371 Date: Dec. 15, 2024

(30) Foreign Application Priority Data
Jun. 22, 2022 (DE) 10 2022 206 246.9

(51) Int. Cl. B01L 3/00

(52) U.S. Cl. CPC B01L 3/502753; B01L 2200/04; B01L 2300/0681

(57) ABSTRACT

Disclosed is a microfluidic system having a housing and having at least one flow channel formed within the housing, wherein at least one element that has an ion exchanger mixed-bed resin is arranged in at least one sub-region of the flow channel, and at least the flow channel is formed from a porous material, wherein the ion exchanger mixed-bed resin is intended, by way of its anion and cation exchanger properties, to reduce the ion concentration of a salt or of a contaminating compound of a fluid medium that has macromolecular compounds and/or cellular structures.

The invention relates to a microfluidic system having an ion exchanger mixed-bed resin, a method for producing a cartridge based on the system, the cartridge itself, and a method for reducing an ion concentration of a salt or of a contaminating compound in a fluid medium that has macromolecular compounds and/or cellular structures.

In electrolyte systems, an accurate knowledge of the ions present therein, as well as an accurate and reproducible adjustment of an ion concentration, is essential, for example, to adjust the electrical conductivity, pH value and osmotic concentration of one or more electrolytes. These parameters therefore represent basic influencing variables in biological and chemical processes, such as experiments with DNA, proteins and cells.

An ion concentration can be reduced, e.g. by dilution steps. However, if high dilutions are required, a correspondingly high starting volume of the diluent is to be expected. This may result in space issues, among other things, because sufficient amounts of a corresponding clean diluent must be pre-stored and reagents already used must be trapped in waste compartments. A dilution has no selectivity towards individual ion types and the actual analyte is also diluted, possibly to below the detection limit of the method used. In addition, optimum mixing and/or homogenization must be ensured for dilution steps to avoid concentration gradients.

This is a challenge, especially in microfluidic systems. If, for example, the conductivity of 1 ml of physiological PBS solution is to be reduced from approximately 14000 μS/cm per dilution to 1 μS/cm, the addition of 13999 ml DI water with a conductance of approximately 1 μS/cm (dilution 1:14000) is necessary, although it must be noted that the concentration of the analyte is also reduced by the same ratio.

Another way to adjust the ion concentration is by using dialysis filters. These have a certain selectivity in terms of the ionic size, but their universality is very limited in their possibilities. The use of dialysis filters is a diffusion driven process, which depends on the concentration gradient of the compartments separated by the dialysis membrane. Thus, time is a limiting factor. This is predominantly in large sample volumes or systems with a large characteristic dimension L, because the diffusion time of a molecule scales with the square of L.

In addition, the lower limit of deionization is defined by an equilibrium setting of the ion concentration in the compartments. By regularly using fresh liquids, the concentration gradient can be maintained. However, the amount of fresh reagents that can be pre-stored in miniaturized lab-on-chip systems is limited. In addition, integrability and handling is challenging as a microfluidic system designed specifically for this purpose is needed. The use in miniaturized microfluidic systems further impairs the efficacy due to the unfavorable surface-to-volume ratio. Use in disposable cartridges would increase manufacturing costs in addition and would not be economically viable.

If one wants to accelerate the dialysis process and decouple the process from concentration gradients, it makes sense to apply pressure in order to achieve mixing. Such processes come into play, for example, in sea water desalination plants. However, the integrability and handling in lab-on-chip systems is even more difficult to implement. In addition, the membrane may become clogged, reducing the efficacy of the deionization process. In addition, the membrane and sample may be destroyed at too high pressures.

In addition, extraction and precipitation methods are also known in the deionization of solutions. These represent complicated processes that are difficult to integrate and manage in microfluidic systems. Especially in extraction methods, toxic and material-compatible chemicals are often used. In addition, these processes are somewhat undefined, which is reflected in their reproducibility. In precipitation methods, certain anions and cations may be added in order to selectively precipitate certain ions by forming an insoluble salt, but this is particularly unfavorable in microfluidic systems, as the system may become blocked. Adherence of the resulting solid phase to the system can thus negatively affect the process.

Furthermore, deionization methods with so-called “carbon nanotubes” have already been described.

Capacitive deionization (CDI) is another method for deionization of water in which an electrical potential difference is generated by two electrodes. However, this method is not suitable for microfluidic systems intended as single-use products in terms of integrability, manageability and cost. In addition, such systems have not yet been used for biological or chemical samples.

All methods used according to the prior art for deionization methods have in common a limited to non-existent compatibility with microfluidic systems as well as a limitation due to limited possibilities of miniaturization or scaling.

In the deionization of tap water on a macroscopic scale (by the liter or kilogram), ion exchanger mixed-bed resins are integrated into desalination cartridges, where tap water flows through them to deionize them. If its ion exchanger capacity is depleted, the desalination cartridges may be exchanged or regenerated. The ion exchanger material is generally made of porous polystyrene beads, which can be functionalized with a wide variety of ion exchanger groups. These have an average diameter of approximately 0.6 mm, wherein each bead has either an anion or cation exchanger function.

Anion exchanger columns are also known from the purification of DNA-containing solutions, which bind the DNA contained in the solution to anion exchanger gels, wherein the remaining solution passes through the anion exchanger gel in a centrifugation step. DNA bonded to the anion exchanger can be washed and then eluted back from the column material. However, in this case the DNA is specifically isolated from the solution and not the contaminating salts or ions.

Document DE 10 2008 000 369 A1 discloses an integration of a sample preparation into a microfluidic device. The device can comprise a preparation substance on one side of a substance exchange membrane. The preparation substance may comprise an ion exchanger for desalination of the sample, because an excessive salt concentration may be undesirable for a separation method following the preparation. The device may be configured to prepare a biological sample containing DNA, proteins, enzymes, cells, bacteria or viruses.

The publication WO 00/71243 A1 discloses the use of microfluidic systems that use microsphere matrices to detect target analytes. The target analyte may be a nucleic acid. A described device may comprise a separation module configured to separate contaminants that interfere with the analysis of the target analyte. The separation module may contain ion exchanger materials as separation media.

Document DE 10 2013 201 505 A1 discloses a device for extracting dry pre-stored body fluids in a sample, a cartridge, and a method for extracting the body fluid. The device is configured as a lab-on-chip system and may comprise a filter or purification device for the body fluid extracted from the sample. The purification device may be an ion exchanger.

Document DE 100 46 069 A1 describes a method and microfluidic elements for micro-polynucleotide synthesis. The microfluidic elements used may comprise portions in which there are ion exchanger resins that allow direct separation of products from reagents. An ion exchanger is provided to provide a separation process in the presence of polynucleotides.

The task is to reduce the concentration of ions and of certain ion types defined in an electrolyte. The invention is intended to enable deionization for an application with limited process volumes, such as those handled in microfluidic systems. The invention is intended to gently deionize fluid media that has macromolecular compounds and/or cellular structures, such as those found in biotechnology or chemistry.

This object is achieved by a microfluidic system according to claim 1, a method of manufacturing a cartridge according to claim 11, a cartridge according to claim 14, and a method of reducing the ion concentration of a salt or of a contaminating compound of a fluid medium that has macromolecular compound and/or a cellular structures according to claim 15

Further advantageous embodiments and configurations of the invention arise from the dependent claims, the figures and the exemplary embodiments. Embodiments of the invention may be advantageously combined with one another.

A first aspect of the invention relates to a microfluidic system having a housing and having at least one flow channel formed within the housing, wherein at least one element that has an ion exchanger mixed-bed resin is arranged in at least one sub-region of the flow channel, and at least the flow channel is formed from a porous material, wherein the ion exchanger mixed-bed resin is intended, by way of its anion and cation exchanger properties to reduce the ion concentration of a salt or of a contaminating compound of a fluid medium that has macromolecular compounds and/or cellular structures.

For example, the fluid medium may be a solution or a suspension. The fluid medium may in particular be a sample to be examined in which a particular analyte, such as a diagnostic marker, is to be detected. For example, the macromolecular compounds may be nucleic acids and/or proteins.

The invention solves the above-described problem advantageously because arranging an ion exchanger mixed-bed resin has a comparatively high deionization or ion-binding surface to total volume ratio, which can reduce an ion concentration in a space-saving manner. Furthermore, it is advantageous that a sample does not need to be diluted, so that large volumes of diluent do not need to be provided in a space-saving manner. In addition, the sensitivity of subsequent detection methods is not affected by inappropriate dilution of the sample.

Furthermore, the invention is advantageous because no minimum ion concentration is necessary to achieve an equilibrium. A lower concentration limit can be set to virtually and depth and only depends on the volume of the ion exchanger mixed-bed resin (or the available ion exchanger groups available). Ionic concentrations similar to those of deionized water may thus be achieved.

A selectivity or affinity of the ion-exchanger mixed-bed resin to different ion types may be advantageously controlled by functionalizing the ion exchanger mixed-bed resin with suitable surface groups. A change in the ratio of anion exchangers to cation exchangers may also further increase selectivity.

Furthermore, the invention advantageously allows for gentle deionization of the fluid medium without compromising or destroying the actual analyte in the fluid medium. No aggressive chemicals or high pressures are necessary (e.g. for precipitation or extraction methods), which can degenerate system components or contaminate and negatively affect subsequent process steps.

The invention can thus be implemented without high technical cost and thus allows universal integrability in microfluidic systems. In addition, the amount of mixed-bed resin used can be scaled as required with the size of the microfluidic system or with the fluid to be deionized (conductivity and volume).

The term “deionizing” is used herein to mean that an ion concentration of a salt or a contaminating compound in a fluid medium or solution is significantly reduced. Ideally, said ion concentration is reduced to zero. However, this term does not include macromolecular compounds (macromolecules) being removed from the solution, which may also be present as ions and which are precisely what is desired, i.e. which are to be freed of salt ions and contaminating compounds. In particular, the terms “deionizing” and “deionization” are synonymous with “reducing” or “reduction” with respect to the ion concentration.

Preferably, the element is arranged such that the fluid medium can flow around it as it flows through the flow channel. Advantageously, as large a contact as possible between the surface of the element and the medium is enabled. In this way, ions from the medium are efficiently bonded to the element. Advantageously, a number of elements are arranged in the flow channel, thereby providing more surface area for interaction with ions in a sample. The element or elements are provided, for example, in the form of small particles, e.g. as balls or beads. In a preferred embodiment, the elements may also have small dimensions such that they are provided as powders. This may further increase the efficiency of the reduction of ion concentration due to their greater surface area. It may also be moved through the microfluids as a fine suspension after being received in a fluid.

Preferably, the element consists of an ion exchanger mixed-bed resin. In other words, the element is made entirely of a material, namely the ion exchanger mixed-bed resin, which is not mixed with other materials. This makes it advantageous to provide a material from which the element(s) can be manufactured. This increases the efficiency of manufacture and the efficiency of interaction with the ions in the fluid medium.

At least the flow channel of the system according to the invention is configured from a porous material, preferably a porous polymeric material. This is advantageous because the porous material can be passed through by the fluid medium and small ions, such as ions from dissolved salts, but not by an element made of or with an ion exchanger mixed-bed resin or by macromolecular compounds such as biomolecules like proteins, nucleic acids or cells, or only slowly compared to salt ions. Pore sizes of 3000 to 5000 daltons are therefore suitable to ensure this selective permeability. This provides another important advantage, in particular in the case of a fluid medium having an analyte in the form of a biomolecule, such as a nucleic acid. Due to their charges, such biomolecules are also bonded to ion exchanger mixed-bed resins, albeit much slower than small salt ions. The porous material of the flow channel enables deionization of the fluid medium without loss of charged biomolecules by binding the biomolecules to the ion exchanger mixed-bed resin. This is particularly advantageous in the processing of patient samples in diagnostics, as the sample material contained therein, in particular the diagnostic markers sought, is strongly limited so that a further loss of sample material could prevent the successful detection of the desired markers.

In a preferred embodiment, the element is embedded in at least a portion of the material forming the flow channel. In other words, the element is immobilized in the material. The element can thereby be introduced into cavities provided in the material and bonded to the material there, for example. This may be carried out, for example, during the manufacturing process of the material, e.g. by introducing it into the material during an injection molding process or by applying and compressing it into the still soft polymer.

In a preferred embodiment, polymeric porous material is arranged with the element in the flow channel, such that the fluid medium can flow through it. The material is arranged transversely to the flow direction of the fluid medium in the flow channel. The material is conceivable in the form of a precisely fit porous frit (or a filter) arranged in the flow channel. The thickness of the frit can be chosen as desired, wherein a greater thickness is associated with better deionization efficiency, as the ions dissolved in the fluid have more time to interact with the ion exchanger material as they pass through the frit. The thickness is limited by the pressure that the microfluidic system can apply to move the fluid. In one embodiment, the element itself can be formed as a frit.

In a further preferred embodiment, the material is arranged with the element in the flow channel, such that the fluid medium can flow tangentially against it. The inner surface of the flow channel is essentially lined with the material. The material is then largely flowed against tangentially and no longer through completely, as with the frit. Thus, it provides a lower resistance. In addition, the efficiency of reducing the ion concentration may be improved by sufficiently long incubation times. In one embodiment, the element itself can form the liner material.

Preferably, a film-like device made of a polymeric porous material is arranged in the area of the flow channel. Here film-like means that the device has a laminar configuration and is dimensioned significantly larger in height and width than in thickness. The film-like device is referred to as a film in the following. The film may be provided from the same material as the surroundings of the flow channel or from another polymeric material.

Particularly advantageously, the film is arranged transversely to the flow direction in the flow channel in order to trap elements located in the fluid medium from or with ion exchanger mixed-bed resin. The elements are pre-stored in a carrier liquid and flushed into the system at the desired time. Contact between the elements and the fluid medium reduces the ion concentration in the medium. After passing through the film, the medium has fewer ions and no elements. The film represents the effective reduction volume.

In a particularly preferred embodiment, the film is functionalized with ion exchanger groups. The element or a number of elements are arranged in the film. In an alternative embodiment, the ion exchanger mixed-bed resin itself may also be provided as a film, i.e. in a thin, porous form. The formation of a film with elements or the element as a film is advantageous because it can be pre-assembled as a single part and fitted into a particular microfluidic system. The film is then arranged within the flow channel like the carrier material described above transverse to the flow direction so that it can be flowed through alone or with a further carrier material, or on an inner side of the flow channel. Here too, the effective reduction volume corresponds to the film volume through which the flow passes or the tangential flow.

In a further preferred embodiment, a first flow channel and a second flow channel are formed within the housing, which are in fluid connection with each other. In the area of the fluid connection, a film is preferably arranged between the flow paths, which forms a semi-permeable delineation between the first and second flow channels. Embodiments of the film are suitable in which no elements are integrated, which is then particularly suitable to trap elements from the fluid medium. Furthermore, embodiments of the film comprising elements are also suitable for binding salt ions from the fluid medium. The effective reduction volume corresponds to the film volume through which the flow passes. Alternatively to using a film, the fluid connection may also be configured as a constriction between the two flow channels where the elements may be immobilized. In each case, it is contemplated to introduce the fluid medium into the first flow channel and discharge it from the second flow channel with a significantly reduced ion concentration.

A second aspect of the invention relates to a method for manufacturing a cartridge comprising a system according to the invention, with the steps of:
providing a number of layers of a polymeric material, which, depending on their planned position within the cartridge, have a shape such they can form a flow channel within the housing, and at least the flow channel is formed from a porous material,
providing at least one element comprising an ion exchanger mixed-bed resin,
arranging the layers and the element together such that a flow channel is formed and the element is located in at least a sub-region of the flow channel and cannot exit the flow channel,
assembly of the layers.

Preferably, the element is provided with the layers forming the flow channel. The element can be integrated in the material, i.e. in the manufacture of the corresponding layers, e.g. through an injection molding process, are mixed into the material or sink into the still soft material. Alternatively, in the corresponding layers, depressions, e.g. recesses in different geometric shapes, can be formed that receive the elements.

Particularly preferably, a film made a polymeric material is provided in the method. The film has been described above. The film may be made of the same polymeric material as the layers or comprise another polymeric material. The film may, for example, comprise or also consist of an ion exchanger mixed-bed resin.

Preferably, the elements are integrated into at least one region of the film. Specifically, elements are arranged in desired areas of the film. This is advantageously material- sparing when the film is arranged between two flow channels and comprises the elements only in the immediate flow path.

The film is preferably arranged in the flow channel transverse to the flow path of the fluid medium. Alternatively, the film can also be arranged longitudinally to the flow channel. The film here allows an arrangement of elements after the actual manufacture of the cartridge so that the cartridge can be manufactured from layers in a cost-saving manner without integrating the elements into the layers.

A third aspect of the invention relates to a cartridge for reducing the ion concentration of a salt or of a contaminating compound of a fluid medium that has macromolecular compounds and/or cellular structures manufactured by a method according to the second aspect of the invention. The advantages of the cartridge correspond to the advantages of the method according to the invention. For example, the cartridge may be provided as a so-called lab-on-chip cartridge and utilized in the development of biological or molecular biological testing and methods.

A fourth aspect of the invention relates to a method for reducing the ion concentration of a salt or of a contaminating compound of a fluid medium that has macromolecular compounds and/or cellular structures by means of a cartridge according to the invention, with the steps:
providing the cartridge,
instilling the fluidic medium into the flow channel,
incubation of the fluid medium in the flow channel,
discharging the fluid medium from the flow channel for further use.

The method advantageously allows for a reduction in ion concentration of a salt or a contaminating compound in biological and chemical samples on a micro and nanoliter scale.

Preferably, the desired level of reduction of the ion concentration of the fluid medium is controlled by the amount of ion exchanger mixed-bed resin used and/or by selecting the ion exchanger groups in the ion exchanger mixed-bed resin. In this way, a cartridge for a particular fluid medium to be reduced may be advantageously used. Furthermore, a cartridge may also be used according to a particular target, e.g. if a particular application requires a special purity of the fluid medium from salt ions, or if certain ions are to be removed as an alternative. Selective reduction can be controlled to some extent by processing different ion groups during the manufacturing process. In addition, the proportion of anion exchangers as well as cation exchangers in the mixed-bed resin can be adjusted. The surface available for ion exchange is also critical and can be adapted for the respective application.

In a further preferred embodiment of the method, the desired level of reduction of the ion concentration of the fluid medium is controlled by the duration of incubation of the fluid medium in the flow channel. If the fluid containing the ions is incubated statically with the mixed-bed resin, i.e. without setting a flow, the reduction of the ion concentration is a purely diffusion-driven process. If the diffusion coefficients of the desired or undesired ions are known, the time factor can be used to exert a further influence on the selectivity of the process.

It is also possible to non-selectively bind all ionic components to a mixed-bed resin followed by a defined microfluidic addition of desired ions. Alternatively, a deionized solution may also be conveyed to liquid or powdered pre-stored ions to be received again in the fluid.

The invention will be explained in further detail with reference to the drawings. The figures show:

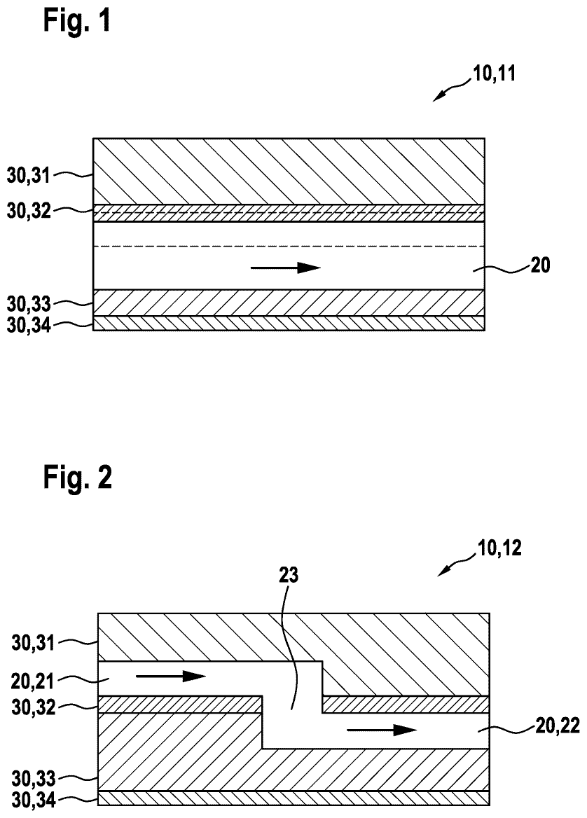

FIG. 1 a cartridge according to one embodiment of the invention having a flow channel.

FIG. 2 a cartridge according to one embodiment of the invention having two flow channels.

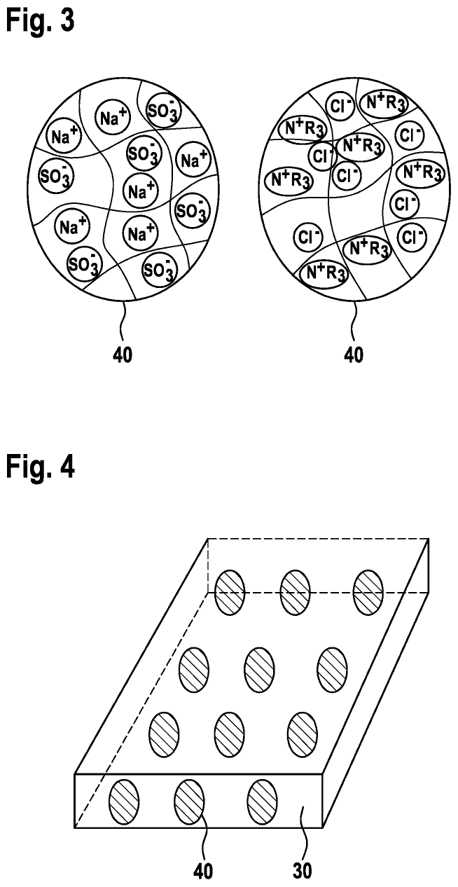

FIG. 3 a schematic illustration of elements from ion-exchanger mixed-bed resin.

FIG. 4 a schematic illustration of an arrangement of the elements according to FIG. 3 in a layer of the cartridge.

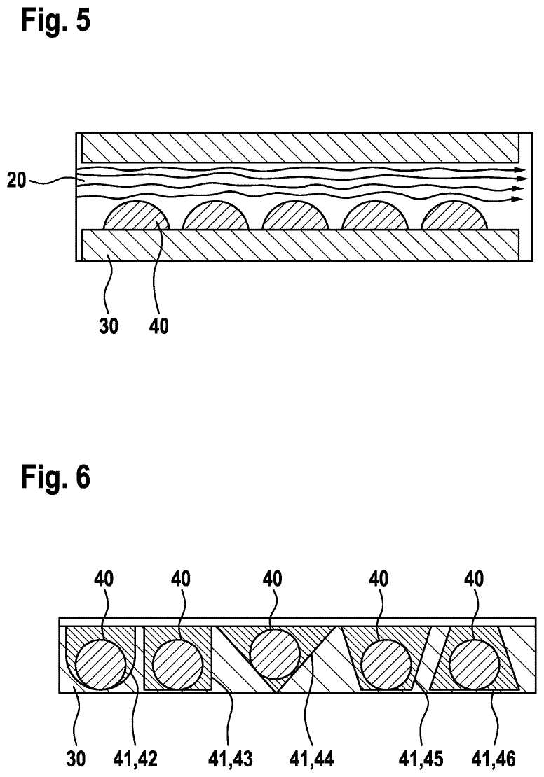

FIG. 5 a schematic illustration of an arrangement of the elements in the surface of a flow channel of the cartridge.

FIG. 6 a schematic representation of cavities in the surface of a flow channel in various configurations.

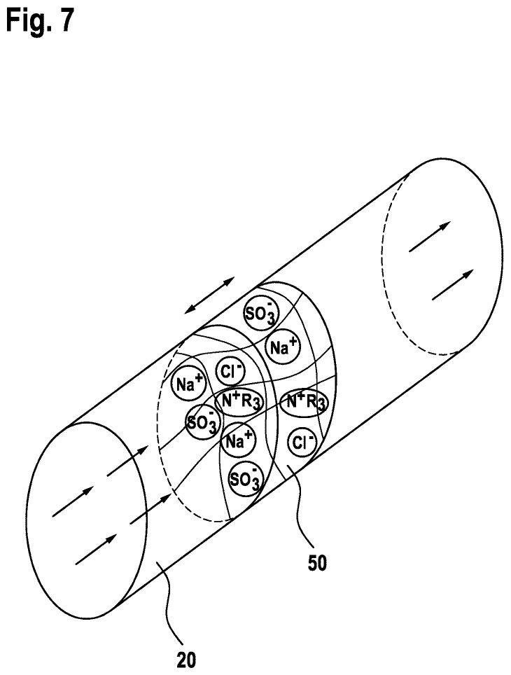

FIG. 7 a schematic illustration of a flow channel having frits arranged therein with or from the ion exchanger mixed-bed resin.

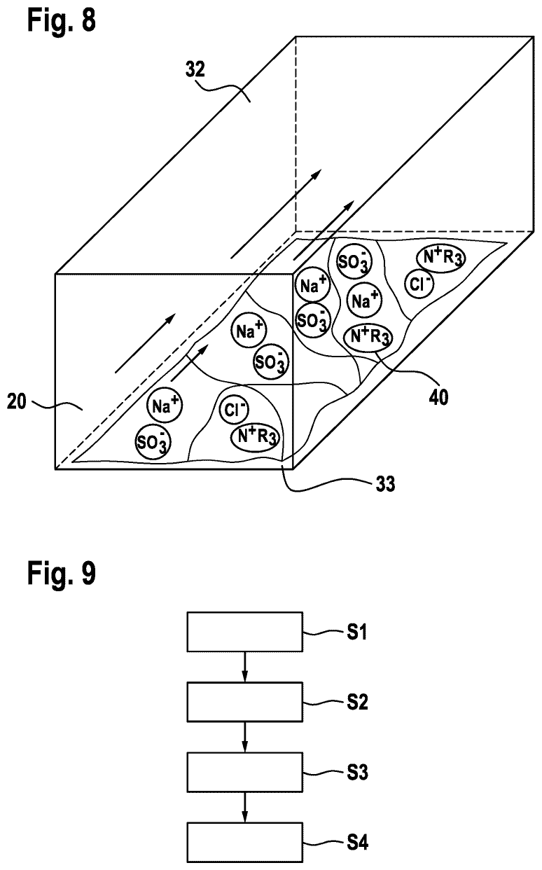

FIG. 8 a schematic illustration of a flow channel with elements from ion exchanger mixed-bed resin arranged in the material of the flow channel formation.

FIG. 9 a flow diagram of an embodiment of the method according to the invention for manufacturing a cartridge.

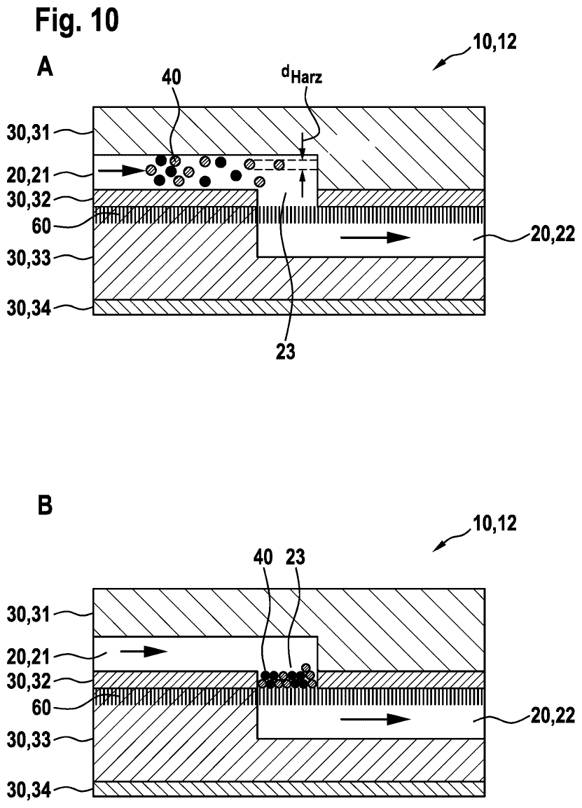

FIG. 10 a cartridge with two flow channels and a film.

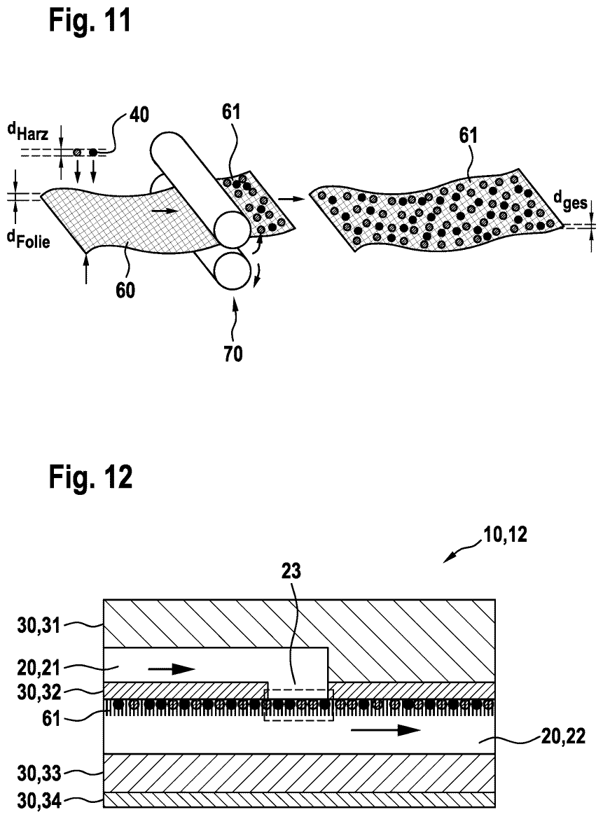

FIG. 11 the manufacture of a film functionalized with ion exchanger mixed-bed resin.

FIG. 12 a cartridge with two flow channels and one film functionalized with ion-exchanger mixed-bed resin.

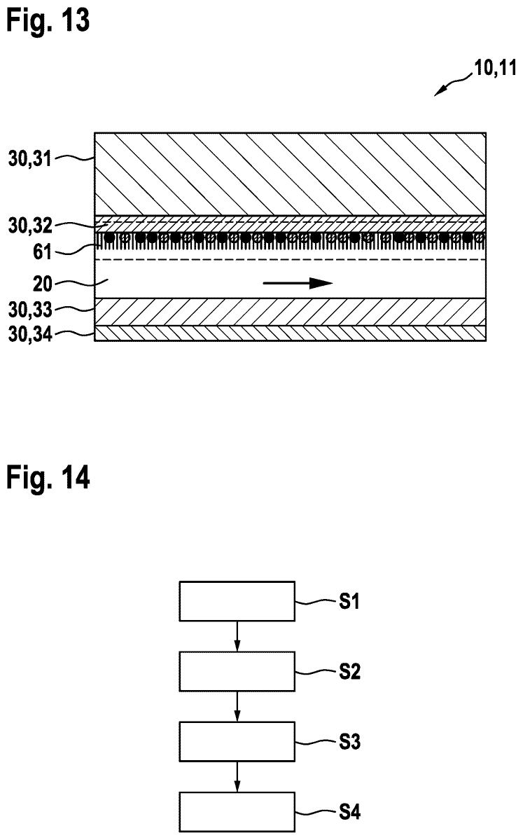

FIG. 13 a cartridge having a flow channel and a film functionalized with ion-exchanger mixed-bed resin.

FIG. 14 a flow diagram of an embodiment of the method according to the invention for reducing an ion concentration by means of a cartridge.

In FIG. 1 a cartridge 10 is shown, which is configured as a cartridge 11 with a flow channel 20. The cartridge 11 comprises four layers 30, namely a first layer 31, a second layer 32, a third layer 33, and a fourth layer 34. The flow channel 20 is formed through the second layer 32 and the third layer 33. The material of the layers 30 is particularly a porous polymer, such as polycarbonate; other suitable polymeric materials may also be used. The pore size of the material should therefore be defined, such that an ion exchanger mixed-bed resin in powder form or as beads, as well as biomolecules such as proteins, nucleic acids or cells, cannot enter or enter the material slowly compared to salt ions. On the other hand, smaller molecules, such as dissolved salts, are intended to be able to pass through the material. Pore sizes of 3000 to 5000 daltons are therefore suitable to ensure this selective permeability. This provides another important benefit, especially in biomolecules such as nucleic acids. Due to their charges, these molecules are also bonded to ion exchanger mixed-bed resins, albeit much slower than small salt ions.

FIG. 2 shows a cartridge 10, which is configured as a cartridge 12 having a first flow channel 21 and a second flow channel 22. The number of layers 30 in the layer-like structure corresponds to that of the cartridge 11 according to FIG. 1. In contrast to FIG. 1, the first layer 31 and the third layer 33 each have different material thicknesses in sections in the cartridge 12, so that they allow the formation of the first 21 or second flow channel 22 in the sections of smaller thicknesses. The first flow channel 21 and the second flow channel 22 are connected by a fluid connection 23. The fluid connection is provided by a tunnel in the second layer 32. The fluidic connection 23 allows at least one flow of a liquid; it may be configured as a constriction, such that element located in the liquid cannot pass through or be provided for arranging a film.

The cartridge 10 is provided to reduce a concentration of salt ions and/or ions of contaminated compounds in an ionic liquid. The ionic liquid may also be referred to as an ionic solution or as a fluid medium and has particularly macromolecular compounds and/or cellular structures. To reduce the concentration of salt ions and/or ions of contaminating compounds in the ionic liquid, elements 40 are used that have an ion exchanger mixed-bed resin or in a preferred embodiment consist of the ion exchanger mixed-bed resin. FIG. 3 shows two elements 40, wherein one is an anion exchanger element and the other is a cation exchanger element having the respective immobilized ions SO₃ and N⁺R₃, as well as the mobile counterions (Na⁺ and Cl⁻). The functionalization is fixed/immobilized and forms the framework of the element together with the resin matrix. Ion exchangers may be functionalized with a variety of ions. The counterions serve to ensure the ion exchange function. In order for the elements to have an ion exchange function, the functional groups must absolutely be loaded with (very) mobile ions. The cation exchanger must be loaded with a cation, and the anion exchanger must be loaded with an anion. Anions and cations can also be functionalized on an element. The resin used as the carrier material is in particular a porous polystyrene, wherein other suitable polymers may also be used.

The elements 40 are provided in approximately spherical form (as spherical as possible) and have a diameter of 0.1 mm-1.2 mm. The elements 40 may also be mechanically further crushed, e.g., by grinding, until they are in powder form. This embodiment is particularly suitable for being employed in a suspension.

FIG. 4 shows an embodiment of the invention in which the element 40 is embedded in a layer 30. Here the elements 40 are directly immobilized in the material of the layer 30. The porous material of the layer 30 has filter properties. This arrangement can be used to counteract the loss of charged biomolecules contained in an ionic liquid, as only small charged molecules can penetrate the filter material to interact with the mixed-bed resin and the biomolecules, which are generally macromolecules, cannot bond to the mixed-bed resin. In other words, by packing the elements 40 in the porous material of the layers 30, deionization of the ionic liquid can occur without loss of charged biomolecules by binding to the ion exchanger mixed-bed resin.

FIG. 5 shows an embodiment of the invention in which elements 40 are arranged in the area of the surface of a layer 30. The elements 40 can be embedded in the material of the layer 30, for example by pressing them into the still soft polymeric material during the manufacture of the layer 30. Alternatively, cavities 41, e.g. recesses or indentations, can also be formed in the layer 30, in which the bodies are arranged. Such cavities 41 may have various geometries, e.g. a rounded shape 42, a quadrilateral 43, a triangular 44, a first trapezoidal 45, and a second trapezoidal 46 (FIG. 6).

In FIG. 7, a flow channel 20 is shown in which an ion exchanger filter configured as a frit 50 is arranged. The frit 50 is arranged transversely to the flow direction of an ionic liquid (indicated by the arrows) precisely in the flow channel 20. In this way, as much surface area as possible for ion exchange is provided while also providing optimum flow of the polymeric material. In one embodiment, the frit 50 has the same material as the layers 30 of the cartridge 10, i.e. a porous polymeric material, in particular polycarbonate, are embedded in the element 40. In another embodiment, the frit 50 consists of the ion exchanger mixed-bed resin, in other words it is the element 40. The thickness of the frit 50 can be chosen as desired, wherein a greater thickness correlates with a higher efficiency, as the ions dissolved in the fluid can interact with the ion exchanger material over a longer period of time as they pass through the frit 50. The thickness of the frit 50 is thereby limited by the pressure that can be provided to the cartridge 10 to move the fluid. It is possible to arrange a plurality of frits 50 in succession in the flow channel 20. These may then be anion and cation exchanger frit.

FIG. 8 shows a flow channel 20 whose lower boundary is formed by the layer 33 and the upper boundary is formed by the layer 32. Elements 40 are arranged in the surface of the layer 33. A corresponding arrangement may be provided as explained in FIGS. 5 and 6. In this embodiment, an ionic liquid (flow direction indicated by the arrows) flows tangentially towards them. Alternatively, a lining of the layer 33 (or further layers 30 forming the flow channel 20) with ion exchanger mixed-bed resin is also possible.

In FIG. 9, one embodiment of a method for manufacturing a cartridge 10 in the form of a cartridge 12 with two flow channels is shown by means of a flow chart. In a first step S1, four layers 31, 32, 33, 34 of porous polycarbonate (or other suitable polymeric material) are provided that have a shape depending on their planned position within the cartridge that allows for the formation of at least one flow channel and housing. More specifically, the first layer 31 and the third layer 33 each have different material thicknesses in sections, such that they allow the formation of the first 21 and second flow channel 22 in the sections with smaller thicknesses. The second layer 32 comprises a tunnel provided for forming a fluid connection 23 between the first 21 and the second flow channel 22.

In a second step S2, an element 40 or a number of elements 40 having an ion exchanger mixed-blend resin is provided. In a preferred embodiment, the elements 40 consist of the ion exchanger mixed-bed resin. The elements 40 can be easily integrated during assembly of the cartridge 10. If the element 40 is to be clamped statically in the desired flow channel 20 as in a “sandwich”, a prior size selection, e.g. by sieving, is recommended. Static clamping of the elements 40 can prevent slippage and possible blockage of the flow channels 20. In addition, the elements 40 can be prevented from escaping from the cartridge structure, which could lead to problems during the build-up process by means of laser welding. This is particularly important as the elements 40 can become electrostatically charged and shift from their intended installation position. Placement of the element 40 in the intended flow channel 20 can also be made possible by spreading the elements 40 on a corresponding layer 30, whereby the elements 40 reach depressions in the layer 30. Regions that are to remain free of elements 40 can be covered or briefly provided with a negative of the corresponding layer 30 during insertion of the element 40. Excess bodies 40 that prevent the cartridge from closing properly during the manufacturing process can be removed by shaking, wiping or a blower, for example.

In a third step, S3, the layers 30 and the element(s) 40 are arranged together such that a flow channel is formed and the elements are is located in at least a sub-region of the flow channel and cannot be allowed to exit the flow channel.

In a fourth step S4 the layers 30 are assembled. The assembly may be performed by, for example, laser welding, gluing, or another suitable method.

In a further embodiment of the method, a film 60 is provided. The film 60 consists of a porous polymeric material, e.g., polycarbonate, polypropylene, polyethylene, polyvinylchloride or polyamide, and/or other polymers having glass transition temperatures comparable to that of polystyrene, which preferably consists of the ion exchanger mixed-bed resin of the elements 40. The film 60 is integrated into the cartridge during construction, namely, such that it covers at least the tunnel of the second layer 32, so that a fluid medium, i.e. an ionic solution, will in any case flow through it.

In one embodiment, the film 60 is provided for trapping the flushed element 40, also in powder form, into a cartridge 12 with two flow channels 21, 22. These are pre-stored in a carrier liquid and flushed into cartridge 12 at the desired time (FIG. 10A). Due to the flow of an ionic liquid directed through the cartridge 12, the elements 40 are trapped at the fluid connection junction 23 through the film 60 (FIG. 10B). A direct pre-storage on the film 60 is also possible before an ionic liquid is conveyed via the ion exchanger mixed-bed resin. The “filter cake” made of ion exchanger mixed-bed resin represents the effective volume for reducing the ion concentration of the ionic liquid.

The deionization capacity (also total capacity) of an ion exchanger mixed-bed resin system is typically indicated in data sheets in equivalents per liter (eq/L). It denotes the number of active groups (˜6.02.10²³ per equivalent and valence=1, derived from the Avogadro constant) available relative to the value (valence) of an ion to be bonded, which can be found in a liter of resin mixture on a variety of exchanger resin granules. Depending on the active group used, a general distinction is made between strongly and weakly acidic cation exchange resins (SACs) and weakly acidic cation exchange resins (WACs) and between strongly basic anion exchange resins (SBAs) and weakly basic anion exchange resins (WBAs), each with different total capacities.

By way of example, the deionization efficiency can be described using a Purolite MB 400 ion exchanger mixed-bed resin (data sheet: https://www.perst.ro/wp-content/uploads/2018/09/Purolite-MB400.pdf). It is an ion-exchanger mixed-bed resin whose active groups are sulfonates (—SO³— and thus SACs bound with H⁺ in the delivery form) in the cation exchanger with a total capacity of 1.9 eq/L and quaternary ammonium ions (—N(CH3)³⁺ and thus SBAs bound with OH⁻ in the delivery form) in the anion exchanger with a total capacity of 1.3 eq/L (the volume ratio of cation exchanger to anion exchanger is 40% to 60%). The average mass density (bulk weight) of the resin mixture is 722.5 g/l. Polystyrene beads as polymer carriers have an average bulk density of 1050 g/l and an average diameter of 0.6 mm.

Accordingly, 1 ml of a 150 mM NaCl solution (this corresponds to approximately physiological conditions with a conductivity of approximately 14000 μS/cm at 20° C. and a sample volume as typically processed in microfluidic systems) with a mixed-bed resin (MBH) volume of V_{MBH}=115.38 μl can be fully deionized.

MBH volume for complete deionization of 1 ml of 150 mM NaCl solution:

$${V}_{Cl} = ( 0.15 ( mol \text{/l} ) / 1.3 ( \text{eq/l} ) ) \cdot 1 ml = 115.38 µl = {V}_{MBH}$$

This assumes that the resin is unconsumed (disposable use) and has a deionization efficiency of 100% (the electrolyte comes into full contact with the MBH and saturation is present in the deionization reaction).

The required MBH volume is thus sufficiently small (<1 ml) to be able to be integrated relatively easily in a microfluidic system. By comparison: In order to obtain an equivalent deionization result (i.e. equivalent electrical conductivity) by dilution, a 13999 ml/0.11538 ml=1.21·10⁵ larger volume of deionized water must be used or pre-stored in the microfluidic system. It should be note that the concentration of the analyte is not reduced when using an MBH.

On the other hand, the MBH volume is large enough to be still reliably handled in a series production. In V_{MBH}=115.38 μl ion exchanger mixed-bed resin, there are approx.

$${N}_{Ball} = {m}_{MBH} / {m}_{Ball} = {V}_{MBH} * {ρ}_{MBH} / ( 4 / 3 \cdot π \cdot {R}^{3} \cdot {ρ}_{Ball} ) = 115.38 {mm}^{3} \cdot 722.5 µg / {mm}^{3} / ( 4 / 3 \cdot π \cdot {( 0.3 mm )}^{3} \cdot 1050 µg / {mm}^{3} ) \approx 702$$

elements 40.

The film 60 may also be functionalized with ion exchanger mixed-bed resin. FIG. 11 shows the process of functionalizing the film 60 with elements 40. In so doing, the elements 40 are incorporated into the porous polymer carrier film 60 via heatable rollers 70. A functionalized film 61 is produced. The above derivation of the necessary volume of the elements 40 can be related to an area of the film 60 of approx.

$${A}_{MBH} = {N}_{Ball} π \cdot {R}^{2} = 702 \cdot π \cdot {( 0.3 mm )}^{2} \approx 198.5 {mm}^{2}$$

for a monolayer. Assuming that the beads are porous and thus fluidly permeable, this corresponds to a carrier film 60 having effective dimensions ˜14 mm×14 mm, which is quite compatible with classical microfluidic systems (credit card format). This surface requirement can be further reduced by stacking a plurality of films 60 or MBH in a monolayer (2D) to form a multi-layer system (3D).

The roller spacing of the rollers 70 is to be selected so that as stable but flexible functionalized film 61 as possible is produced. Accordingly, values for d_{ges} can be between 10 and 1000 μm, for example. The diameter of the resin beads dᵣₑₛᵢₙ should (slightly) be larger than the thickness of the carrier film 60 d_{film} or than the pore openings of its mesh so that they do not simply fall through the carrier film 60 but can be welded to it in a stable manner.

The functionalized film 61 can then be integrated into the cartridge 10 during the construction of the microfluidic cartridge 10. In a first embodiment, the film 61 is arranged in the same manner as the non-functionalized film 60 between the second and the third layers in a cartridge 12, such that the ionic liquid flows through in any case and ions are bonded by the ion exchanger mixed-bed resin (FIG. 12).

In a second embodiment, the film 61 is arranged with a cartridge 11 along the flow channel 20. The ionic liquid flows tangentially against the film 61 (FIG. 13).

The effective volume is based on the thickness of the film 61, which is multiplied by the effectively flow area of the film 61. In other words, the effective volume for deionization refers to the location in the flow channel where the ionic liquid flows though it (cartridge 12) or flows tangentially (cartridge 11) in order to reduce ionic concentration therein.

In FIG. 14, an embodiment of the method according to the invention for reducing an ion concentration in a fluid medium by means of a cartridge 10 is shown once again as a flow diagram. In a first step S1, a cartridge 10 is provided. In a second step S2, an ionic liquid, e.g. a liquid with macromolecules in which salt ions are also dissolved, is flushed into the flow channel 20. In a third step S3, the ionic liquid is incubated in the flow channel 20 for a duration of 10 min (or other suitable duration). By adjusting the fluid flow, ion exchangers and the ionic liquid may be incubated together for as long as desired. Thereafter, in a fourth step, the fluid medium S4 is discharged from the flow channel 20 for further use.

1. A microfluidic system, comprising:
a housing; and
at least one flow channel formed within the housing,
wherein
at least one element that has an ion exchanger mixed-bed resin is arranged in at least one sub-region of the at least one flow channel,
at least the at least one flow channel is formed from a porous material, and
the ion exchanger mixed-bed resin is configured, by way of its anion and cation exchanger properties, to reduce an ion concentration of a salt or of a contaminating compound of a fluid medium that has macromolecular compounds and/or cellular structures.

2. The system according to claim 1 in which the at least one element is arranged such that the fluid medium can flow around it as it flows through the at least one flow channel.

3. The system according to claim 1 in which the at least one element consists of an ion exchanger mixed-bed resin.

4. A system according to claim 1, wherein the at least one element is embedded in at least a portion of a material forming the at least one flow channel.

5. The system according to claim 1 in which polymeric porous material is arranged with the at least one element in the at least one flow channel such that the fluid medium can flow through it.

6. The system according to claim 1 in which polymeric porous material is arranged with the at least one element in the at least one flow channel such that it can be is flowed against tangentially by the fluid medium.

7. The system according to claim 1 in which a film made of a polymeric porous material is arranged in an the area of the at least one flow channel.

8. The system according to claim 7 in which the film is functionalized with ion exchanger groups.

9. The system according to claim 7 in which a first flow channel and a second flow channel of the at least one flow channel are formed within the housing, which are in a fluid connection with each other.

10. The system according to claim 9 in which the film is arranged between the first flow channel and the second flow channel.

11. A method for manufacturing a cartridge comprising a system according to claim 1, comprising:
providing a number of layers of a polymeric material having a shape selected to provide a flow channel within the housing, using a porous material;
providing at least one element comprising an ion exchanger mixed-bed resin;
arranging the number of layers and the at least one element together, such thatthe flow channel is formed and the at least one element is located in at least a sub-region of the flow channel and cannot exit the flow channel; and,
assembling the number of layers.

12. The method according to claim 11, wherein the at least one element is provided with the number of layers.

13. The method according to claim 11, wherein a film is provided from a polymeric material.

14. A cartridge for reducing an ion concentration of a salt or of a contaminating compound of a fluid medium that has macromolecular compounds and/or cellular structures manufactured by a method according to claim 11.

15. A method for reducing the ion concentration of a salt or of a contaminating compound of a fluid medium that has macromolecular compounds and/or cellular structures using the cartridge according to claim 14, comprising:
providing the cartridge;,
flushing the fluid medium into the flow channel;,
incubating the fluid medium in the flow channel; and,
discharging the incubated fluid medium from the flow channel.
